(19) United States
(12) Patent Application Publication
(10) Pub. No.: US 2012/0191656 A1
(43) Pub. Date: Jul. 26, 2012

(54) System And Method For Common Data Service

(75) Inventors: Ben Baker, Collierville, TN (US); Shana Bertram, Collierville, TN (US); Brian Brittain, Collierville, TN (US); Joshua Burk, Collierville, TN (US); Mike Grafton, Memphis, TN (US); Tim Gregory, Collierville, TN (US); Don Fike, Collierville, TN (US); Lisa Janz, Germantown, TN (US); Kelby Loden, Collierville, TN (US); Matthew Lum, Memphis, TN (US); Tim Martin, Bartlett, TN (US); Jerry E. Purdy, Collierville, TN (US); Rogers D. Stephens, Olive Branch, MS (US); Mike Struminger, Germantown, TN (US); David Twynam, Colorado Springs, CO (US)

(73) Assignee: Federal Express Corporation

(21) Appl. No.: 13/013,916

(22) Filed: Jan. 26, 2011

(51) Int. Cl. G06F 17/30

(52) U.S. Cl. 707/654; 707/E17.005

(57) ABSTRACT

Systems, methods, and computer program products are provided for providing data from a common data service. In one exemplary embodiment, there is provided a method for providing data from a common data service. The method may include receiving data from one or more databases in one or more systems. The method may include storing a duplicate copy of the received data as one or more documents. The method may also include receiving a request for one or more documents of the stored data. The method may further include transmitting the one or more documents of the stored data.

### TECHNICAL FIELD

The present invention generally relates to systems and methods for providing data in a common data service. More particularly, the present invention relates to systems and methods for storing data from different systems in a common data service and providing the data from the common data service.

### BACKGROUND

Companies often store data in numerous databases. These databases may be located in different cities, states, or countries. A company usually accesses a specific database for particular information. For example, some company information may be stored in databases located in Memphis, Tenn.; Colorado Springs, Colo.; and/or Brussels. Each database may contain customer information regarding customer names, addresses, accounts, and shipment data. If the company wants to retrieve information from a database located in Memphis, the company may access the database in Memphis. Similarly, if the company wants to retrieve information from a database located in Brussels, the company may access the database in Brussels.

This method of accessing information may be time-consuming, especially if there are time delays which result from both distance and the load on the database storage server. For example, if a company in Brussels sends a request for information stored in Memphis, the request may be transmitted through several servers before reaching the server in Memphis. This results in a time delay.

Moreover, corresponding data may be stored in different databases. If the company wants to retrieve data for a particular customer, the company may have to request the data from more than one database (e.g. Memphis and Colorado Springs) because different customer information may be stored in the different databases. Querying and receiving information from multiple databases may result in additional time delays.

In addition, databases that are located in different areas may need to contain the same information. Therefore, if a database in Memphis is updated to store additional information, the databases in Colorado Springs and Brussels may need to communicate with the database in Memphis to also receive this updated information. Likewise, any updated information in the database in Colorado Springs and Brussels may need to be sent to the other appropriate databases.

Accordingly, there is a need to store all data contained in one or more databases in a central location. To address these needs, a system is needed to store a global copy of all information contained in one or more databases in a local data service.

### SUMMARY

In one exemplary embodiment, there is provided a method for providing data from a common data service. The method may include receiving data from one or more databases in one or more systems. The method may include storing a duplicate copy of the received data as one or more documents. The method may also include receiving a request for one or more documents of the stored data. The method may further include transmitting the one or more documents of the stored data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary computing system that can be used to implement embodiments of the invention;

FIG. 2 illustrates an exemplary common data terminal that can be used to implement embodiments of the invention;

FIG. 3 illustrates an exemplary computing terminal that can be used to implement embodiments of the invention; and

FIG. 4 illustrates a flowchart of an exemplary method for providing data from a common data service consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

System Architecture

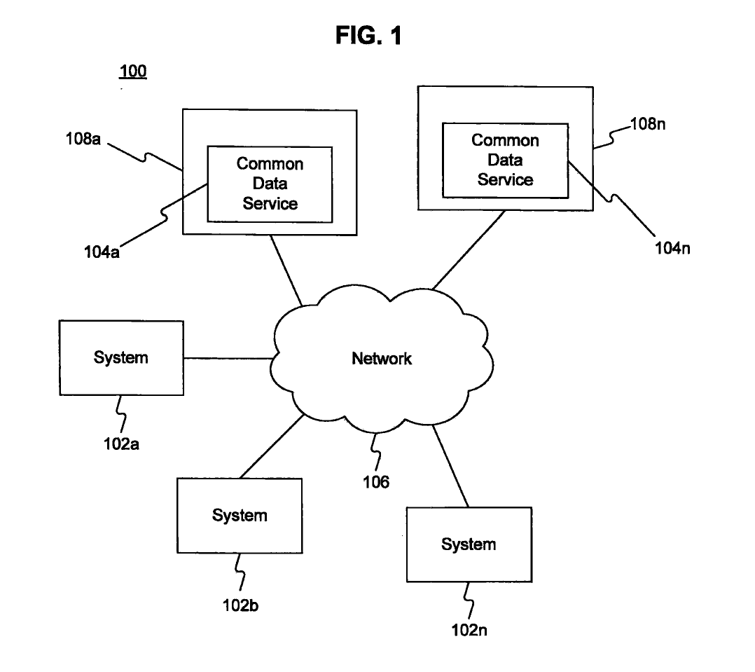

By way of a non-limiting example, FIG. 1 illustrates a system 100 in which the features and principles of the present invention may be implemented. The number of components in system 100 is not limited to what is shown, and other variations in the number of arrangements of components are possible, consistent with embodiments of the invention. The components of FIG. 1 may be implemented through hardware, software, and/or firmware. System 100 may include systems 102a, 102b, and 102n, common data service 104a-104n, network 106, and clients 108a-108n.

Network 106 provides communications between or among the various entities depicted in system 100. Network 106 may be a shared, public, or private network, and may encompass a wide area or local area. Network 106 may be implemented through any suitable combination of wired and/or wireless communication networks (including Wi-Fi networks, GSM/GPRS networks, TDMA networks, CDMA networks, Bluetooth networks, or any other wireless networks). By way of example, network 106 may be implemented through a wide area network (WAN), local area network (LAN), an intranet, and/or the Internet. Further, the entities of system 100 may be connected to multiple networks 106, such as, for example, to a wireless carrier network, a private data network, and the public Internet.

Systems 102a-102n may include one or more processors, such as computers. Systems 102a-102n may each contain one or more databases that store one or more tables of data. The data may include, for example, customer information including a customer name, address, identification number, invoice number, and tracking information for a shipment.

Common data service 104a-104n may be located in clients 108a-108n, and may contain one or more databases that store one or more tables of data. Common data service 104a-104n may be implemented using a combination of hardware, software, and/or firmware, and may be operable to receive and store data from various systems 102a-102n. For example, common data service 104a-104n may search for and receive data, from systems 102a-102n, regarding customer information. The data may include, for example, customer information including a customer name, address, identification number, invoice number, and tracking information for a shipment.

Common data service 104a-104n may be operable to respond to requests for data. For example, a customer may use client 108a to enter a request for data stored at common data service 104a. The request may include one or more triggering parameters, which can be used to find the requested data. When common data service 104a-104n receives a request for data from any of clients 108a-108n, common data service 104a-104n may search a database resident at common data service 104a-104n and return the requested data, if found.

Common data service 104a-104n may provide a service that contains data generically. The service may be viewed as a service framework that is designed to provide generic data access and reduce complexity by reducing both interfaces and uncontrolled replication. Common data service 104a-104n may be designed to be a standardized interface for commonly accessed data (e.g. data located in systems 102a-102n). When clients 108a-108n want to receive data stored in systems 102a-102n, clients 108a-108n may send a request to common data service 104a-104n instead of sending a request directly to systems 102a-102n. Common data service 104a-104n may be viewed as a reusable service that may be configured to support data including, for example, data regarding customers, locations, and shipments.

Common data service 104a-104n may employ a fast, scalable service to provide the requested data to clients 108a-108n. The service provided by common data service 104a-104n may include a multi-data center fault-tolerance that may be available for query, even during large loads within system 100. The multi-data center fault-tolerance may be available at each layer of common data service 104a-104n, such as, for example, service layer 206, utilities 208, and data access layer 210, as described below. Therefore, if a common data service (e.g. common data service 104a) is unavailable, requesting clients 108a-108n may be redirected to a different common data service (e.g. common data service 104b) that is available in a different location. Similarly, if one or more layers of common data service 104a-104n is unavailable, requesting clients 108a-108n may be redirected to a corresponding layer in a different common data service (e.g. common data service 104b) that is available in a different location.

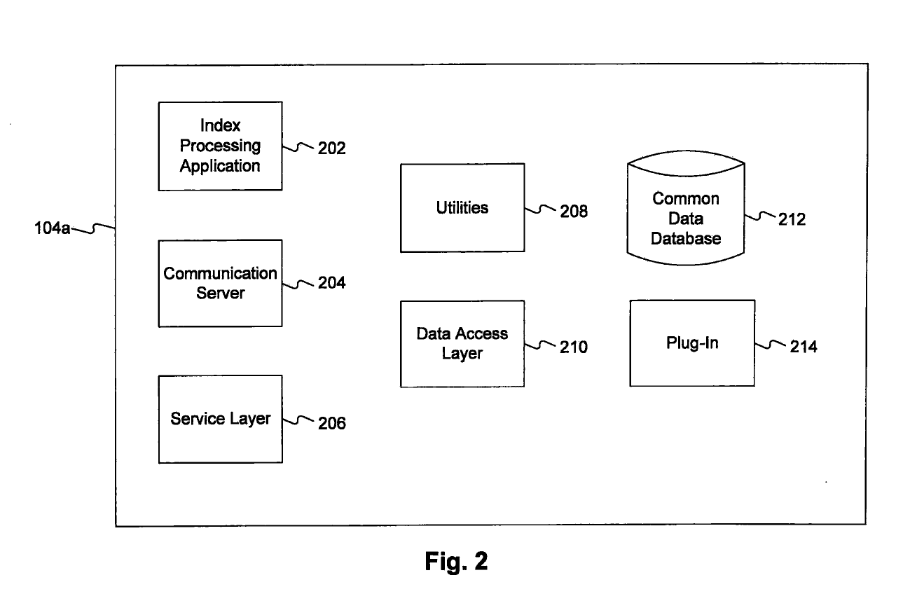

The service may be called by an application running on clients 108a-108n instead of being integrated with a relational database. The service provided by common data service 104a-104n may replace the traditional application to database interaction by providing an eXtensible Markup Language (“XML”) based web service where data is available in multiple locations, and may employ a service framework designed for mastering data. The service may also provide an active design to permit multi-data center fault-tolerance, and may include a generic database design and a code base (e.g. database 212 in FIG. 2) for storing compressed XML data as one or more XML documents. The service may provide searchable fields that may be mapped to a key for retrieving the XML data. The XML data may be compressed to provide smaller data files for retrieval and presentation to clients 108a-108n.

The service provided by common data service 104a-104n may provide for the creation of new domains and data types that may be added through configuration of the service through the database. The service may replicate the data stored in systems 102a-102n and store the replicated data as XML data as stated above. The service may provide operations for querying the data, inserting data, modifying data, and deleting data.

The service may also provide the ability to search and present data independent of the type of database located in systems 102a-102n. Accordingly, numerous types of database located in systems 102a-102n may be used and interchanged without affecting the service.

Clients 108a-108n may provide users with an interface to network 106. By way of example, clients 108a-108n may be implemented using any device capable of accessing a data network, such as a general purpose computer or personal computer equipped with a modem or other network interface. Clients 108a-108n may also be implemented in other devices, such as a Blackberry™, Ergo Audrey™, mobile phones (with data access functions), Personal Digital Assistant (“PDA”) with a network connection, IP telephony phone, or generally any device capable of communicating over a data network.

Clients 108a-108n may be utilized by users to request data from common data service 104a104n. In order to request data, the user may enter information on client 108a indicative of the desired data. After the user enters this information, client 108a may send a request to common data service 104a-104n, which in turn may search its database. When common data service 104a-104n finds the requested data, it may send the data back to clients 108a-108n.

FIG. 2 is a diagram of an exemplary common data service 104a consistent with the present invention. Common data service 104a may include at least an index processing application 202, communication server 204, service layer 206, utilities 208, data access layer 210, common data database 212, and plug-in 214. The number of components in common data service 104a is not limited to what is shown and other variations in the number of arrangements of components are possible, consistent with embodiments of the invention.

Index processing application 202 may perform certain functions, operations, and steps related to embodiments of the present invention. Index processing application 202 may receive requests for data from clients 108a-108n, and may query the requests against the data stored in common data database 212. As previously stated, the data stored in common data database 212 may be XML data that corresponds to the data stored in systems 102-102n. The XML data may be indexed to enable quick, efficient searching and presentation to clients 108a-108n.

Index processing application 202 may also create an index of data that may be tables created based on the searching needs of clients 108a-108n. According to an exemplary embodiment, index processing application 202 may create one table per index, and may populate the data in the index tables at a predetermined or user-defined time. The processing may be configured based on the needs of the user and any application that may be running. For example, the processing may by synchronous or asynchronous. If the processing is synchronous, the index of data that may need immediate creation may be created in an insert transaction. If the processing is asynchronous, the index of data that may not need immediate creation may be deferred and sent to a queue.

Index processing application 202 may also be used to input, update, and delete information contained in the tables of data. Index processing application 202 may also be used to insert data so that it is available for query, and may process one or more fields of data for searching.

Communication server 204 may be a web server that provides functionality for receiving traffic over a network, such as the Internet. For example, communication server 204 may be a standard web server that a user may access at client 108a using a web browser program, such as Safari, Internet Explorer, or Netscape Communicator. Communication server 204 is operable to receive requests for data from clients and pass the requests on to common data database 212 for processing.

Service layer 206 may provide an interface to allow clients 108a-108n access to the data located in database 212. Service layer 206 may include a query that may be used to query the processed data that is processed by index processing application 202. Service layer 206 may be implemented to “hide” the data located in database 212 and structure from client 108a. This may occur because the XML data located in database 212 may be a global copy of the data stored in systems 102a-102n. In addition to storing the XML data in database 212, service layer 206 may also store the XML data and metadata that may define any relationship that may exist between the XML data.

The data stored in systems 102a-102n may also be stored in database 212 as duplicate XML data, as previously stated. This stored data may be presented to clients 108a-108n and may also be sent to systems 102a-102n. For example, if system 102a updates the stored data to reflect a customer shipment, this information may need to be stored in each of systems 102b-102n. According to known systems, this updated data may be sent to systems 102b-102n directly. However, according to an exemplary embodiment, this updated data may be sent to common data service 104a, and common data service 104a may store this data as a duplicate copy in XML format. Common data service 104a may also transmit this data to systems 102b-102n, and systems 102b-102n may update the corresponding database to reflect receipt and storage of this data.

In addition to storing the data as a duplicate copy in XML format, common data service 104a may also store versions of the data to reflect characteristics of one or more changes that were made to the data. For example, if a customer account is located in system 102a and contains information regarding three transactions, this data may be stored in common data service 104a as version 1. If the customer account is updated to reflect a fourth transaction, this additional data may also be stored in common data service 104a, and the four transactions may be stored as version 2. These versions of data may be transmitted from common data service 104a to each of systems 102b-102n, and systems 102b-102n may also store this data.

Utilities 208 may be generic components that may be reused in other systems. For example, utilities 208 may include an XML utility that may be used to identify a domain, stanza, and version of the XML data. According to an exemplary embodiment, a stanza may be viewed as one or more subsets of the XML data. The XML utility may also transform the data received from systems 102a-102n into XML data for versioning.

The XML utility may also validate a schema for the XML data. The schema may describe the XML data structure of the data and may also describe any validation rules of the XML data. These validation rules may include, for example, an attribute type, attribute length, and valid values. In order for common data service 104a to provide valid results based on a query from clients 108a-108n, an XML element may be used from the query and may have a maximum length that may be enforced in the XML schema.

The XML utility may also be used to develop an XML schema for data regarding customer information. This data may be viewed as parent data or structures and may include, for example, a customer name, address, and shipment information. Additional data may also be developed and may be viewed as child data or structures. This child data may contain additional supporting details such as, for example, delivery instructions for the parent data corresponding to the customer address. Any delivery instructions may be viewed as a subset of the customer address, and may therefore be considered child data.

The XML utility may also be used to develop an XML schema to enforce valid query combinations from clients 108a-108n. For example, the query may need to include a country name. In addition, the query may need to include a minimum or maximum number of allowable address lines.

Utilities 208 may also be used to develop an XSL transformation (“XSLT”). An XSLT may be an XML-based language that may be used to transform XML documents of data into other XML documents of data. The XSLT may perform validation in addition to the validation that may be performed by the XML schema.

Utilities 208 may also be used to develop a plug-in to perform validation and implementation of additional logic. According to an exemplary embodiment, a Java plug-in may be used. Utilities 208 may also include a data manipulator that may compress and decompress the XML data stored in database 212. The data manipulator may split the XML data to span multiple rows, and the data manipulator may not be confined by the amount of the XML data. By compressing the XML data, the data manipulator may improve the performance of both transactions and data replication.

Data access layer 210 may be used in conjunction with services layer 206 to provide clients 108a-108n with access to the XML data stored in database 212. Data access layer 210 may include an application layer of data access services that may provide a seamless storage and retrieval of the XML data. Data access layer 210 may cache metadata of stanzas, indexes, styles, schemas, and plug-ins.

Common data database 212 may store the data contained in systems 102a-102n as duplicate data. As previously stated, this duplicate data may be stored in XML format. In addition to storing a duplicate copy of the data in XML format, common data database 212 may also store different versions of the data as stated above. For example, if a customer account is located in system 102a and contains information regarding three transactions, this data may be stored in common data service 104a as version 1. If the customer account is updated to reflect a fourth transaction, this additional data may also be stored in common data service 104a, and the data representing the four transactions may be stored as version 2.

Plug-in 214 may be a model to allow development and implementation of custom functions and business rules. According to an exemplary embodiment, plug-in 214 may be specific to each application. The applications may be, for example, customer name, address, and shipments. Plug-in 214 may be implemented to interpret and understand the contents of the XML documents of data. Plug-in 214 may call the web service to send data to a queue, abort an operation, and modify a request for data. The architecture of plug-in 214 may be implemented to enable the creation of new data domains and features that may be added or changed without initiating a new development of common data service 104a.

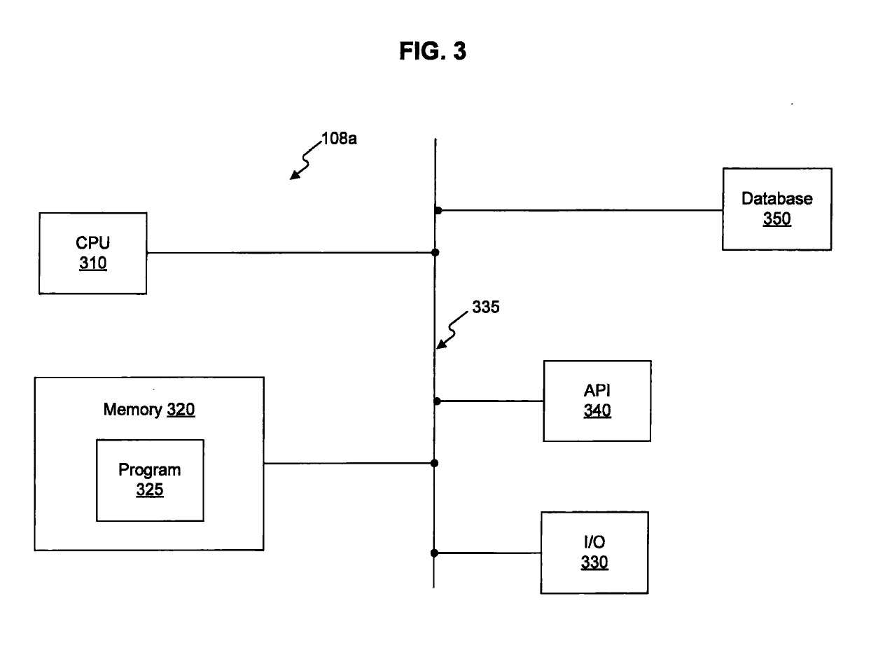

FIG. 3 illustrates an exemplary client 108a that can be used to implement embodiments of the invention. The components and arrangement, however, are not critical to the invention. One of ordinary skill will recognize that embodiments of the invention may be implemented by computers or workstations organized as shown, organized in a distributed processing system architecture, or organized in myriad suitable combinations of software, hardware, and/or firmware.

For example, client 108a may include components such as a central processing unit (CPU) 310, a memory 320, an input/output (I/O) device(s) 330, an application programming interface (API) 340, and a database 350 that can be implemented in various ways. For example, an integrated platform (such as a workstation, personal computer, laptop, etc.) may comprise CPU 310, memory 320, I/O devices 330, API 340, and database 350, interconnected by a local bus 335. In such a configuration, components 310, 320, 330, 340, and 350 may connect through a local bus interface.

CPU 310 may be one or more known processing devices, such as a microprocessor from the Pentium family manufactured by Intel™ or a mainframe-class processor. Memory 320 may be one or more storage devices configured to store information used by CPU 310 to perform certain functions, operations, and steps related to embodiments of the present invention. Memory 320 may be a magnetic, semiconductor, tape, optical, or other type of storage device. In one embodiment, memory 320 includes one or more software application programs 325 that, when executed by CPU 310, perform various processes consistent with the present invention.

Methods, systems, and articles of manufacture consistent with the present invention are not limited to programs configured to perform dedicated tasks. For example, memory 320 may be configured with a program 325 that performs several functions consistent with the invention when executed by CPU 310. Alternatively, CPU 310 may execute one or more programs located remotely from client 108a. For example, client 108a may access one or more remote programs that, when executed, perform functions related to embodiments of the present invention. The configuration and number of programs implementing processes consistent with the invention are not critical to the invention.

Memory 320 may be also be configured with an operating system (not shown) that performs several functions well known in the art when executed by CPU 310. By way of example, the operating system may be Microsoft Windows™, Unix™ Linux™, an Apple™ operating system such as MAC OSX™, Personal Digital Assistant operating system such as Microsoft CE™, or other operating system. The choice of operating system, and even the use of an operating system, is not critical to the invention.

I/O device(s) 330 may comprise one or more input/output devices that allow data to be received and/or transmitted by client 108a. For example, I/O device 330 may include one or more input devices, such as a network connection, keyboard, touch screen, mouse, microphone, disk reader, and the like, that enable data to be input or received from a user. Further, I/O device 330 may include one or more output devices, such as a network connection, display screen, printer, speaker devices, and the like, that enable data to be output or presented to a user. The configuration and number of input and/or output devices incorporated in I/O device 330 are not critical to the invention.

API 340 is an interface used by client 108a to execute user requests. API 340 may be used in conjunction with I/O device 330 to define, for example, monitoring parameters, events, and notifications with respects to shipments. In addition, API 340 may query and receive information regarding shipments in response to information received at I/O device 330. API 340 may also update information stored in databases 204-216.

Database 350 may comprise one or more databases that store information and are accessed and managed through system 100. By way of example, database 350 may be an Oracle™ database, a Sybase™ database, or other relational database. As illustrated in FIG. 2, database 212 may located within common data service 104a. However, the information stored in database 212 may also be located in database 350.

Flowchart

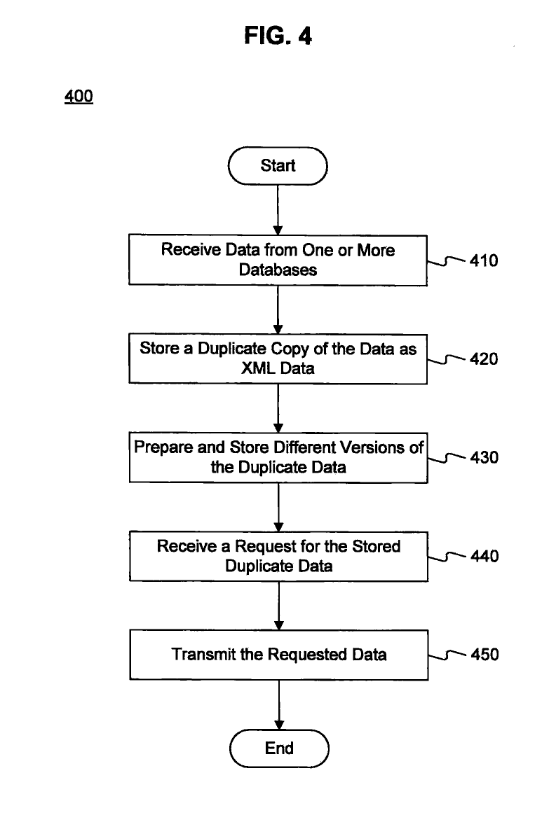

FIG. 4 illustrates a flowchart 400 of an exemplary method for storing data in a common data service, consistent with the principles of the present invention. Although the steps of the flowchart are described in a particular order, one skilled in the art will appreciate that these steps may be performed in a modified or different order, or that certain steps may be omitted or other steps added. Further, one or more of the steps in FIG. 4 may be performed concurrently or in parallel.

Common data service 104a may receive data from one or more systems 102a-102n (step 410). The data received by common data service 104a may include, for example, customer information including a customer name, address, identification number, invoice number, and tracking information for a shipment.

After common data service 104a receives that data, common data service 104a may store a duplicate copy of the data in database 212 (step 420). The duplicate copy of the data may be stored as one or more XML documents of the data.

Upon receiving the data, common data service 104a may also store versions of the data as stated above (step 430). For example, if a customer account is located in system 102a and contains information regarding three transactions, this data may be stored in common data service 104a as version 1. If the customer account is updated to reflect a fourth transaction, this additional data may also be stored in common data service 104a, and the data representing the four transactions may be stored as version 2. These versions of data may be transmitted from common data service 104a to systems 102b-102n, and systems 102b-102n may also store this data.

Clients 108a-108n may send requests for the duplicate data stored in database 212 of common data service 104a. If client 108a wants to receive data stored in database 212, client 108a may send a request for the duplicate data, and common data service 104a may receive the request (step 440). Upon receipt of the request, common data service 104a may transmit the requested duplicate data to client 108a (step 450).

While certain features and embodiments of the invention have been described, other embodiments of the invention will be apparent to those skilled in the art from consideration of the specification and practice of the embodiments of the invention disclosed herein. Furthermore, although aspects of embodiments of the present invention have been described as being associated with data stored in memory and other storage mediums, one skilled in the art will appreciate that these aspects can also be stored on or read from other types of tangible, non-transitory computer-readable media, such as secondary storage devices, like hard disks, floppy disks, or a CD-ROM, or other forms of RAM or ROM. Further, the steps of the disclosed methods may be modified in various ways, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A computer-implemented method for providing data from a common data service, the method comprising the steps, performed by a computer, of:
receiving data from one or more databases in one or more systems;
storing a duplicate copy of the received data as one or more documents;
receiving a request for one or more documents of the stored data; and
transmitting the one or more documents of the stored data.

2. The method of claim 1, wherein the one or more documents are stored as one or more XML documents.

3. The method of claim 1, further comprising:
storing one or more versions of the duplicate copy of the received data.

4. The method of claim 1, wherein the one or more systems transmits the request for one or more documents of the stored data.

5. The method of claim 1, wherein the data corresponds to customer information including at least one of a customer name, address, identification number, invoice number, and tracking information for a shipment.

6. The method of claim 1, further comprising:
generating a schema corresponding to the received data.

7. The method of claim 1, further comprising:
providing access to more than one version of the one or more documents; and
in response to data creation and change, duplicating the data in each of the one or more databases,
wherein the data is duplicated in a first database prior to duplication in each of the other databases.

8. The method of claim 1, wherein
the one or more databases and common data service are provided in different geographic locations,
the common data service provides a back-up capability with respect to the other one or more databases, and
in the event of a failure of at least one of the one or more databases, the common data service provides data from the other one or more databases.

9. A computer-readable medium containing instructions which when executed on a processor performs a method for providing data from a common data service, the method comprising:
receiving data from one or more databases in one or more systems;
storing a duplicate copy of the received data as one or more documents;
receiving a request for one or more documents of the stored data; and
transmitting the one or more documents of the stored data.

10. The medium of claim 9, wherein the one or more documents are stored as one or more XML documents.

11. The method of claim 9, further comprising:
storing one or more versions of the duplicate copy of the received data.

12. The method of claim 9, wherein the one or more systems transmits the request for one or more documents of the stored data.

13. The method of claim 9, wherein the data corresponds to customer information including at least one of a customer name, address, identification number, invoice number, and tracking information for a shipment.

14. The method of claim 9, further comprising:
generating a schema corresponding to the received data.

15. The method of claim 9, further comprising:
providing access to more than one version of the one or more documents; and
in response to data creation and change, duplicating the data in each of the one or more databases,
wherein the data is duplicated in a first database prior to duplication in each of the other databases.

16. The method of claim 9, wherein
the one or more databases and common data service are provided in different geographic locations,
the common data service provides a back-up capability with respect to the other one or more databases, and
in the event of a failure of at least one of the one or more databases, the common data service provides data from the other one or more databases.

17. A system for identifying duplicate data, comprising:
one or more systems that include data; and
a common data service, wherein the common data service:
receives data from one or more databases;
stores a duplicate copy of the received data as one or more documents;
receives a request for one or more documents of the stored data; and
transmits the one or more documents of the stored data.

18. The system of claim 17, wherein the one or more documents are stored as one or more XML documents.

19. The system of claim 17, wherein the common data service stores one or more versions of the duplicate copy of the received data.

20. The system of claim 17, wherein the one or more systems transmits the request for one or more documents of the stored data.

21. The system of claim 17, wherein the data corresponds to customer information including at least one of a customer name, address, identification number, invoice number, and tracking information for a shipment.

22. The system of claim 17, wherein the common data service generates a schema corresponding to the received data.

23. The system of claim 17, wherein the common data service
provides access to more than one version of the one or more documents; and
in response to data creation and change, duplicates the data in each of the one or more databases,
wherein the data is duplicated in a first database prior to duplication in each of the other databases.

24. The system of claim 17, wherein
the one or more databases and common data service are provided in different geographic locations,
the common data service provides a back-up capability with respect to the other one or more databases, and
in the event of a failure of at least one of the one or more databases, the common data service provides data from the other one or more databases.
